(19) United States
(12) Patent Application Publication
(10) Pub. No.: US 2016/0029294 A1
(43) Pub. Date: Jan. 28, 2016

(54) SYSTEM AND METHOD FOR AUTOMATICALLY PROVIDING CONTENT IN ACCESS AREAS BASED ON ACCESS POINTS

(71) Applicant: ESTEEM CO., LTD., Seoul (KR)

(72) Inventor: Gye-Young KIM, Chungcheongnam-do (KR)

(73) Assignee: ESTEEM CO., LTD., Gangnam-gu, Seoul (KR)

(21) Appl. No.: 14/650,806

(22) PCT Filed: Apr. 18, 2014
(86) PCT No.: PCT/KR2014/003416

§ 371 Date: Jul. 10, 2015

(30) Foreign Application Priority Data
Apr. 19, 2013 (KR) 10-2013-0043567
Apr. 18, 2014 (KR) 10-2014-0046631

(51) Int. Cl. H04W 48/04; H04W 48/16; H04W 52/28; H04W 4/02

(52) U.S. Cl. CPC H04W 48/04; H04W 4/021; H04W 48/16; H04W 4/028; H04W 52/283; H04W 84/12

(57) ABSTRACT

Provided is a system and method for automatically providing content in access areas based on access points, in which when a user enters an area in which an access point is installed, content corresponding to the content providing area is automatically provided to a terminal of the user.

### BACKGROUND

The present invention generally relates to a system for providing content. More particularly, the present invention relates to a system and method for automatically providing content in access areas based on access points, in which when a user enters an area in which an access point (AP) is installed (hereinafter, referred to “content providing area”), content corresponding to the content providing area is automatically provided to a terminal of the user.

Generally, unlike a conventional Local Access Network (LAN) technology that connects terminal devices using cables, a wireless LAN technology is a network technology capable of wirelessly transmitting and receiving data between terminals within a certain distance. As standards for the wireless LAN, there are IEEE802.11, IEEE802.11a, IEEE802.11b, IEEE802.11g, IEEE802.11n, and the like.

Recently, use of wireless LAN technology has become widespread in businesses and the cost thereof has become lower. Additionally, the penetration rate of a variety of user terminals has rapidly increased, and includes smart devices having wireless LAN functions, such as smart phones, smart pads, and the like; Personal Digital Assistants (PDAs) having wireless LAN functions; and laptops and tablet PCs, having wireless LAN functions.

In particular, with the increase of the smart devices, relevant technologies using a wireless LAN have quickly developed, and various service systems using the wireless LAN technology and smart devices are being developed. Such service systems include a Wi-Fi Positioning system (hereinafter, referred to “WPS”) and a content providing system for providing various types of content, such as information, applications, still images, motion pictures, etc. A WPS comprises a technique for obtaining wireless AP information, a technique for constructing a database by optimizing the obtained AP information, a technique for obtaining necessary information from a user's mobile terminal, and a technique for obtaining the position of a corresponding terminal device by comparing the obtained wireless AP information with information in the constructed database.

However, because much time and cost are required to construct and maintain a database in order to provide services based on positions, commercialization is costly and it is expensive to maintain the quality of the services.

Also, because a content providing system is a passive information providing system that provides information only when a user requests specific content, the user is required to search for necessary content and is likely to spend much time searching for corresponding information.

### SUMMARY OF THE INVENTION

Accordingly, an object of the present invention is to provide a system and method for automatically providing content in access areas based on access points, in which when a user enters an area in which an access point (AP) is installed (hereinafter, referred to “content providing area”), content corresponding to the content providing area is automatically provided to a terminal of the user.

In order to accomplish the above object, a system for automatically providing content in access areas based on access points, according to the present invention, includes: a plurality of access points, installed to allow a Wi-Fi zone to cover a certain content providing area, for providing access point information; one or more content providing units, having multiple pieces of content for one or more content providing areas, for providing content when receiving a request for the content; a wireless LAN information management unit for storing and managing content information based on an access point, the content information being set according to each of the access points installed in the content providing area, and for providing content information corresponding to access point information when receiving a content search request signal including the access point information; and a user terminal for detecting the access point, acquiring content information corresponding to the access point information of the access point, connecting to a content providing unit corresponding to the content information, and downloading and executing corresponding content.

The user terminal includes: a storage unit for storing content based on an access point; a wireless communication unit for receiving a wireless signal transmitted from any access point, detecting access point information included in the received wireless signal, and outputting the access point information; and a control unit for acquiring content information corresponding to the access point information of the access point when the wireless communication unit detects the access point, connecting to a content providing unit corresponding to the content information, and downloading and executing corresponding content.

The wireless communication unit includes: a transmitter-receiver unit in which a wireless signal is transmitted to and received from a certain access point and the received wireless signal is decoded and output; and an RSSI measurement unit for measuring and outputting an RSSI of the wireless signal received from the access point. The control unit includes: an access point detection unit for detecting access point information from the decoded data, and outputting the access point information; an entry detection unit for determining entry into a content providing area by determining whether the RSSI of the received wireless signal is greater than a predetermined reference value for determining entry when the access point is detected by the access point detection unit, the RSSI being measured by the RSSI measurement unit; a content search unit for transmitting the content search request signal including the access point information to the wireless LAN information management unit via the wireless communication unit when determining the entry into the content providing area, and for receiving content information in response to the content search request signal; and a content execution unit for connecting to a content providing unit corresponding to the received content information, downloading corresponding content, storing the content in the storage unit, and then executing the content.

The wireless communication unit includes: a transmitter-receiver unit in which a wireless signal is transmitted to and received from any access point and the received wireless signal is decoded and output; and an RSSI measurement unit for measuring and outputting an RSSI of the wireless signal received from the access point. The control unit includes: an access point detection unit for detecting access point information from the decoded data, and outputting the access point information; an entry detection unit for determining entry into a content providing area by determining whether the RSSI of the received wireless signal is greater than a predetermined reference value for determining entry when the access point is detected by the access point detection unit, the RSSI being measured by the RSSI measurement unit; a content search unit for requesting and receiving a content providing area information list including pieces of content providing area information from the wireless LAN information management unit via the wireless communication unit when an event of updating content providing area information occurs, the content providing area information including both area information of a content providing area and access point information, for storing the content providing area information list, and for determining whether content providing area information, which includes access point information identical to the access point information detected when determining the entry into the content providing area, is included in the content providing area information list; and a content execution unit for connecting to a content providing unit corresponding to content information of content providing area information when the content providing area information including access point information identical to the detected access point information exists, downloading corresponding content, storing the content in the storage unit, and then executing the content.

The user terminal further includes a sensor unit that includes one or more of a gyro sensor, an acceleration sensor, and a geomagnetic sensor, and the control unit further includes: a movement determination unit for determining whether a user is moving, depending on whether a user terminal is in motion using a sensed value measured by the sensor unit; and a power management unit for deactivating the wireless communication unit when the movement determination unit determines that the user remains stationary, and activating the wireless communication unit when it is determined that the user is moving.

The user terminal further includes a GPS module for measuring a current position of the user terminal using position data and absolute time data, received from GPS satellites. The movement determination unit of the control unit determines whether the current position is an indoor location or an outdoor location using the GPS module when the GPS module is activated. The power management unit deactivates the wireless communication unit when it is determined by the GPS module that the current position is an outdoor location, and activates the wireless communication unit when it is determined that the current position is an indoor location.

The user terminal further includes: a display unit; and an input unit that includes a home button and a display on/off change button. The power management unit of the control unit deactivates the wireless communication unit when a screen of the display unit is turned off, and activates the wireless communication unit when the screen is converted from the off state into an on state by pressing the home button or the display on/off change button.

The storage unit stores a time for automatically converting to a power saving mode, and the control unit further includes a timer for calculating a current time, and deactivates the wireless communication unit when the current time is the time for automatically converting to the power saving mode, and activates the wireless communication unit when the current time is not the time for automatically converting to the power saving mode.

A big data management unit for receiving and managing user agreement information for the user terminal is further included, and the user terminal provides the user agreement information to the big data management unit while the content is executed or when execution of the content has been completed.

The user agreement information includes user information, and content providing area information for a content providing area in which the user is located, provision of the user information being agreed upon by the user.

The access point information includes an SSID and a MAC address.

The content information is one or more of app identification information, membership card information, and URL information, which correspond to a content providing area.

When the content information is app identification information, the user terminal determines whether an app corresponding to the app identification information is installed, and when the app is not installed, the user terminal downloads the app from a corresponding content providing unit and installs the app.

In order to accomplish the above object, a method for automatically providing content in access areas based on access points, according to the present invention, includes: a content information obtaining process in which content information corresponding to AP information of a detected AP is obtained when a user terminal detects the AP; and a content execution process in which the user terminal connects to a content providing unit corresponding to the obtained content information and downloads and executes content corresponding to the content information.

The content information obtaining process includes: a content providing area information list request step for requesting a content providing area information list including multiple pieces of content providing area information from a wireless LAN information management unit when an event of updating content providing area information occurs, the multiple pieces of content providing area information including both content area information including content information and AP information; a download step for downloading the content providing area information list from the wireless LAN information management unit in response to the request, and storing the content providing area information list in a storage unit.

The content information obtaining process includes: a content search request step in which, when an AP is detected, a content search request signal including AP information of the detected AP is generated and transmitted to the wireless LAN information management unit; and a content information obtaining step in which content information is obtained by receiving the content information corresponding to the AP information from the wireless LAN information management unit in response to the request.

The content search request step includes: an AP detection step in which a control unit of the user terminal detects an AP depending on whether a wireless signal is received from any AP through a wireless communication unit; a content providing area entry determination step in which an RSSI of the wireless signal received from an AP is measured when the AP is detected, and whether the user terminal enters a content providing area is determined by checking whether the measured RSSI is greater than a previously stored reference value for determining entry into a content providing area; and a content search step in which a search of content is requested when it is determined that the user terminal enters a content providing area.

The content search request step further includes a content storage determination step in which it is determined whether content for AP information of the detected AP is previously stored in the storage unit when it is determined that the user terminal enters the content providing area in the content providing area entry determination step. In this case, if the content for the AP information is stored in the storage unit, the stored content is executed, and if not, the content search request step is performed.

The content execution process includes: an app determination step in which the user terminal determines whether content of the content information is an app when receiving the content information; an app installation determination step in which when the content of the content information is an app, whether the app has been installed is checked; a content download step for connecting to a content providing unit corresponding to the content information when the app has not been installed, and downloading the app that is content corresponding to the content information; an app installation step in which the downloaded app is installed; and an app execution step in which the installed app is executed.

The method further includes a power saving mode setting process for determining whether a current state is either a power saving mode or a power saving disable mode; deactivating a wireless communication unit when the current state is the power saving mode; and activates the wireless communication unit when the current state is the power saving disable mode. The content information obtaining process and the content execution process are performed in the power saving disable mode.

The power saving mode setting process includes: an power saving mode determination step in which it is determined whether a current state is either a power saving mode or a power saving disable mode; and a wireless communication unit activation/deactivation step in which the wireless communication unit is activated or deactivated depending on the set power saving mode.

The power saving mode determination step includes: a sensed value collecting step in which a sensor unit collects sensed values according to movement of the user terminal; a user movement determination step in which whether a user is moving is determined depending on the movement of the user terminal by the sensed values; and a power saving mode setting step for setting the power saving disable mode when the user is moving, and setting the power saving mode when the user remains stationary.

The power saving mode determination step includes: a display off detection step for determining whether a screen of a display unit is turned off; a display on detection step for determining whether a home button signal or a display change button signal is input from an input unit while the screen is turned off; and a power saving mode setting step for setting the power saving mode when the screen is turned off, and setting the power saving disable mode when the screen is turned on.

According to the present invention, when a user enters a certain content providing area, which is covered by a Wi-Fi zone formed by any AP, content for the content providing area is automatically displayed on a user terminal that is wirelessly connected to the AP. Accordingly, the user easily finds various pieces of information related to the content providing area.

Also, the present invention has effects of collecting and using user information and information about a content providing area in which a user is located, the user information being for analyzing users' moving paths, visiting patterns of users who visit a content providing area, and the like.

Also, in order to reduce power consumption that is necessary for always operating a wireless communication unit of a user terminal to communicate with an AP, the present invention performs a power control process depending on sensors, a setting time, a specific event, and the residual capacity of a battery, thus minimizing unnecessary consumption of the battery power.

Also, the present invention enables a user to quickly detect various services such as purchase credits and discounts provided by a business operator of a content providing area and to be aware of various pieces of information for the content providing area, through the content provided in the content providing area. For example, if the content providing area is a theater, information notifying a user to put a terminal in vibrate mode may be provided.

Also, according to the present invention, installation of an app, which is provided by a company that provides the content in the content providing area, may be expanded, and the use of the app may be increased when users visit the content providing area. Accordingly, the promotional effects of the app and the company may be increased.

### BRIEF DESCRIPTION OF DRAWINGS

FIG. 1 is a view illustrating a configuration of a system for automatically providing content in access areas based on access points according to the present invention;

FIG. 2 is a view conceptually illustrating a system for automatically providing content in access areas based on access points according to the present invention;

FIG. 3 is a view illustrating a configuration of a user terminal of a system for automatically providing content in access areas according to the present invention;

FIG. 4 is a flowchart illustrating a method for automatically providing content in access areas based on access points according to a first embodiment of the present invention;

FIG. 5 is a flowchart illustrating a method for automatically providing content in access areas based on access points according to a second embodiment of the present invention;

FIG. 6 is a flowchart illustrating a method for automatically providing content in access areas in a first operation example of a user terminal, according to a second embodiment of the present invention;

FIG. 7 is a flowchart illustrating a method for automatically providing content in access areas in a second operation example of a user terminal, according to a second embodiment of the present invention;

FIG. 8 is a flowchart illustrating a method for automatically providing content in access areas in a third operation example of a user terminal, according to a second embodiment of the present invention; and

FIG. 9 is a flowchart illustrating a power management method using a GPS module and a gyro sensor in a user terminal according to the present invention.

### DETAILED DESCRIPTION OF THE INVENTION

Hereinafter, referring to the accompanying drawings, a configuration and operations of a system for automatically providing content in access areas based on access points, according to the present invention, will be described, and a method for automatically providing content in access areas based on access points in the system will be described.

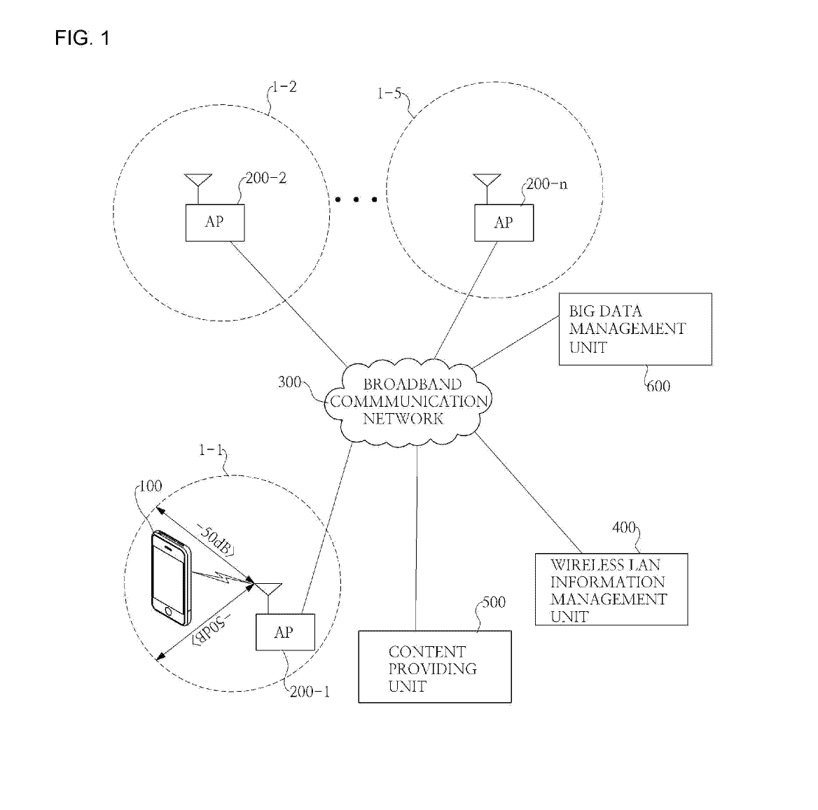

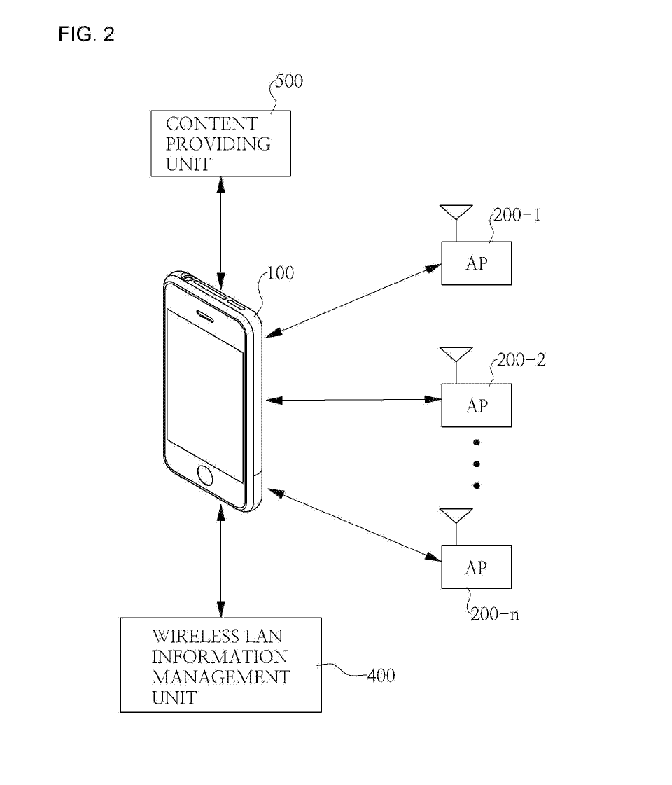

FIG. 1 is a view illustrating a configuration of a system for automatically providing content in access areas based on access points according to the present invention, and FIG. 2 is a view conceptually illustrating a system for automatically providing content in access areas based on access points according to the present invention. Hereinafter, the system will be described with reference to FIGS. 1 and 2. The reference numeral 1 of the drawings represents a content providing area.

A system for automatically providing content in access areas based on access points, according to the present invention, includes a user terminal 100, a plurality of access points (hereinafter, referred to “AP”) 200, a wireless LAN information management unit 400, and a plurality of content providing units 500, and further includes a big data management unit 600 according to an embodiment.

The user terminal 100 connects to a broadband communication network 300 through the AP 200, and performs data communication with both the content providing unit 500 and the wireless LAN information management unit 400, which are connected to the broadband communication network 300. The content providing unit 500, the wireless LAN information management unit 400, and the big data management unit 600 may perform data communication with each other through the broadband communication network 300.

The present invention comprises: a first embodiment in which a content providing area information list including multiple pieces of content providing area information is previously downloaded from the wireless LAN information unit 400 and stored, and a content providing service is automatically provided using the list, the content providing area information including both area information of a content providing area, in which content information according to the content providing area is included, and information about APs installed in the content providing area; and a second embodiment in which whenever an AP is detected, whether the AP corresponds to an AP installed in a content providing area 1 for automatically providing a content providing service is checked, and then the content providing service is automatically provided.

### First Embodiment

A user terminal 100 is a terminal having a wireless LAN function capable of performing wireless data communication with an AP 200, and may include not only smart devices such as a smart phone, a smart pad, etc., but also a laptop computer, a personal computer, a tablet PC, and the like.

The user terminal 100 detects any AP 200 while moving, and connects to a broadband communication network 300 through the detected AP 200.

According to the first embodiment, the user terminal 100 according to the present invention receives a content providing area information list comprising multiple pieces of content providing area information from a wireless LAN information management unit 400, and stores the list, the content providing area information including both area information of a content providing area 1 that automatically provides a content providing service according to the present invention and AP information of an AP 200 installed in the content providing area 1. As described above, the area information includes content information.

When detecting any AP 200, the user terminal 100 determines whether content providing area information for an AP that has the detected AP information is included in the stored content providing area information list. When the content providing area information having the AP information is in the list, the user terminal 100 connects to a content providing unit 500 corresponding to content information included in the content providing area information, and downloads relevant content and executes the content.

The AP information includes a Service Set Identifier (hereinafter, referred to “SSID” or “AP identification information”) and a MAC Address of the corresponding AP 200. Also, the content may be an application corresponding to a content providing area 1 (hereinafter, represented as “app”); computer and mobile web services including still images, motion pictures, text information, and the like, provided from a website of a URL corresponding to the content providing area 1; and a membership service corresponding to the content providing area 1. When the content is an app, the content information may be an app ID and information about the content providing unit 500 that provides the app. If the content is not an app, the content information may be an URL of the content providing unit 500 that provides the content, and if the content is a membership service, the content information may be membership card information, etc.

An AP 200 forms a Wi-Fi zone depending on the communication range of a wireless signal, and is installed in various places such as streets, shops in a building, homes, subways, and the like. The AP 200 stores an SSID and a MAC address, which are assigned thereto, and broadcasts a beacon frame including the SSID and the MAC address to tell the presence of the AP itself. Also, the AP 200 may provide a user terminal 100 with a probe response frame including the SSID and the MAC address when receiving a request from the user terminal 100.

The content providing area 1 may be defined as an area in which the Received Signal Strength Indicator (RSSI) of a wireless signal transmitted from an AP 200 is equal to or greater than a certain value (for example, −50 dB) within a Wi-Fi zone formed by the AP 200.

The wireless LAN information management unit 400 stores and manages multiple pieces of content providing area information, which include area information for a content providing area 1, information about an AP included in the content providing area 1, and content information for the content providing area 1. The content information may be information about a content providing unit 500, which provides an app corresponding to a content providing area 1, and an app ID, or may be URL information of a website that provides information corresponding to the content providing area 1.

When a content request signal is received from a user terminal 100, a content providing unit 500 provides the user terminal 100 with content that is previously set for content information included in the content request signal.

The content providing unit 500 may be an app providing server that provides one or more apps, a web server that provides web pages for providing content, and the like. When the content providing unit 500 is an app providing server, the content providing unit 500 provides a user terminal 100 with an app corresponding to the AP information of an AP 200 that forms a Wi-Fi zone covering the content providing area 1. In this case, if the app has not been installed in the user terminal 100, the app is installed in the user terminal 100.

Also, if the content providing unit 500 is a web server, the content providing unit 500 transmits a web page based on a web service to the user terminal 100 to display the web page.

### Second Embodiment

When detecting any AP 200, a user terminal 100 according to a second embodiment detects AP information of the AP 200, transmits a content search request signal including the AP information to a wireless LAN information management unit 400, receives content information in response to the request signal, connects to a content providing unit 500 that provides content of the received content information, downloads the content, and provides the content to a user.

When receiving the content search request signal including AP information that includes one or more of an SSID and a MAC address from the user terminal 100, the wireless LAN information management unit 400 provides content information corresponding to the AP information to the user terminal 100.

Because the other configurations are identical to those of the first embodiment, the description thereof is omitted.

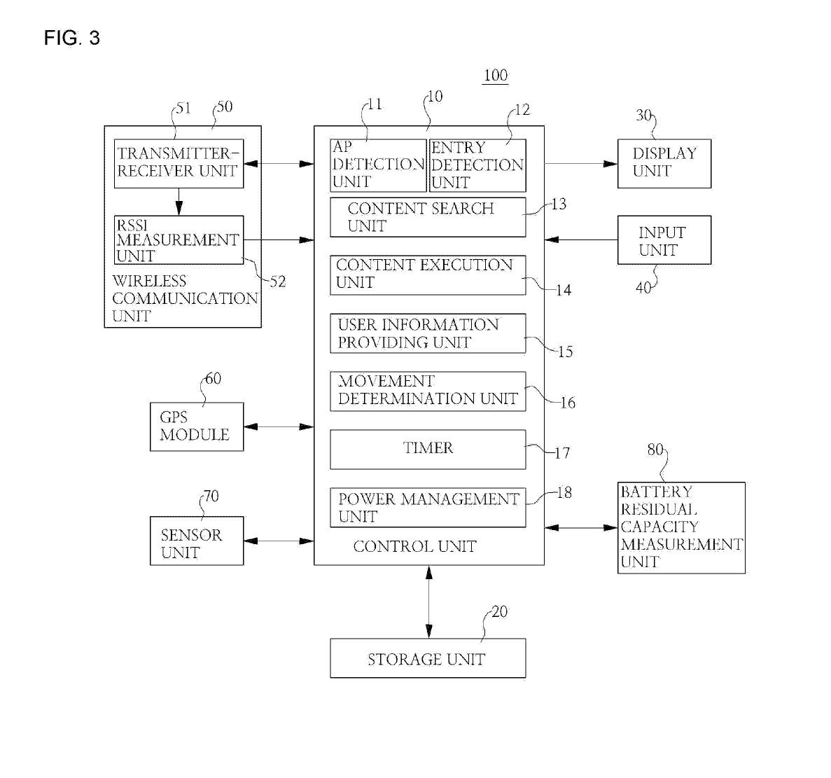

FIG. 3 is a view illustrating a configuration of a user terminal of a system for automatically providing content in access areas, according to the present invention. Hereinafter, the detailed configuration and operations of the components of a user terminal 100 according to the present invention are described with reference to FIG. 3.

A user terminal 100 includes a control unit 10, a storage unit 20, a display unit 30, an input unit 40, a communication unit 50, a GPS module 60, and a sensor unit 70.

The storage unit 20 includes a program area that stores a control program for controlling operations according to the present invention, a temporary area for temporarily storing data generated while executing the control program, and a data area for storing data generated by a user or the control program, such as AP information of a detected AP 200, content according to the AP information, and the like. The storage unit 20 stores a content providing area information list according to the first embodiment of the present invention, and stores AP information and content information for content, which is executed according to the second embodiment of the present invention.

The display unit 30 shows both the operation state of a user terminal 100 depending on the control of the control unit 10 and a display in response to the execution of content according to the present invention.

The input unit 40 includes: a button input device, which has a home button, a display (on/off) change button, a volume button, and the like, and which outputs a button signal for a pressed button to the control unit 10; and a touch pad (touch screen), integrated to a screen of the display unit 30, for displaying information about a screen position touched by a user.

The wireless communication unit 50 includes a transmitter-receiver unit 51 that is wirelessly connected to an AP 200 and performs wireless data communication by transmitting and receiving wireless signals, and an RSSI measurement unit 52 that measures the RSSI of a wireless signal received from the AP 200 through the transmitter-receiver unit 51 and outputs the RSSI to the control unit 10.

The GPS module 60 receives position data and absolute time information from at least three Global Positioning System (GPS) satellites and outputs them to the control unit 10, or measures the current position of the user terminal 100 using the received position data and absolute time information and outputs the current position to the control unit 10.

The sensor unit 70 includes multiple sensors for measuring conditions around the user terminal 100, and outputs values, sensed by the sensors, to the control unit 10. The sensors may include a gyro sensor, a geomagnetic sensor, an acceleration sensor, a gravity sensor, an optic sensor (illumination sensor), and the like.

A battery residual capacity measurement unit 80 measures the residual capacity of a battery (not illustrated) and outputs the value to the control unit 10.

The control unit 10 includes an AP detection unit 11, an entry detection unit 12, a content search unit 13, a content execution unit 14, a user information providing unit 15, a movement determination unit 16, a timer 17, and a power management unit 18, and controls overall operations of the user terminal 100 according to the present invention.

Specifically, the AP detection unit 11 detects any AP 200 depending on whether a wireless signal such as a beacon frame, a probe response frame, etc., is received through the wireless communication unit 50. When an AP 200 is detected, the AP detection unit 11 extracts AP information from a wireless signal and stores it.

When the AP 200 is detected by the AP detection unit 11, the entry detection unit 12 determines whether the user terminal 100 enters a content providing area 1 by determining whether the RSSI measured by the RSSI measurement unit 52 is equal to or greater than a preset reference value.

When an event of updating content providing area information occurs according to the first embodiment of the present invention, the content search unit 13 requests and receives a content providing area information list including pieces of content providing area information from the wireless LAN information management unit 400 via the wireless communication unit, and stores the content providing area information list, the content providing information including area information of a content providing area and AP information. Then, the content search unit 13 determines whether content providing area information including AC information that is identical to the AP information, detected when entry into the content providing area is determined, is included in the stored content providing area information list. The event of updating the content providing area information may be generated when a control program according to the present invention is initially executed, may be generated at a certain time or in day, week, month, and year intervals, or may be generated when a user makes a request.

Also, according to the second embodiment of the present invention, when it is determined by the entry detection unit 12 that the terminal enters any content providing area 1 and content for the content providing area 1 has not been executed, the content search unit 13 generates a content search signal including the AP information and transmits the signal to the wireless LAN information management unit 400. The content search unit 13 receives content information in response to the signal, and stores the content information.

The content execution unit 14 connects to a content providing unit 500 corresponding to the content information, and downloads and executes relevant content, or executes content stored in the storage unit 20.

Depending on a user's agreement on providing personal information, the user information providing unit 15 provides user agreement information to the big data management unit 600 through wireless communication unit 50. The user agreement information includes user information, content providing area information for the content providing area 1, and the like. The user information may include a user's name, age, sex, etc.

The movement determination unit 16 indirectly determines whether a user is moving or not by the user's terminal 100, through the GPS module 60 and the sensor unit 70.

The timer 17 counts a current time and various times used in the user terminal 100.

The power management unit 18 determines whether a power saving mode is set through the movement determination unit 16, the timer 17, on/off information of the wireless communication unit, which is included in the storage unit 20, and a button signal from the input unit 40. If the power saving mode is set, the power management unit 18 deactivates the wireless communication unit 50, and if not, the power management unit 18 activates the wireless communication unit 50.

Specifically, when it is determined by the movement determination unit 16 that a user remains stationary, the power management unit 18 sets the power saving mode. Conversely, when it is determined that the user is moving, the power management unit 18 releases the power saving mode.

Also, the power management unit 18 compares a current time counted by the timer 17 with a predetermined time for automatically entering the power saving mode, and sets the power saving mode when the current time is the time for automatically entering the power saving mode. For example, the time for automatically entering the power saving mode may be a time when a user goes to the bed, and the wireless communication unit 50 is deactivated by setting the power saving mode while the user sleeps.

Also, the power management unit 18 may be configured to activate the wireless communication unit 50 only when a home button is clicked in the input unit 40 or when a display is converted from an off state to an on state.

Also, the power management unit 18 may be configured to necessarily set the power saving mode when the residual capacity of a battery, measured by the battery residual capacity measurement unit 80, is equal to or less than a reference amount.

Also, the power management unit 18 may be configured to manage the battery power by activating or deactivating the wireless communication unit 50, using two or more of the above-mentioned methods.

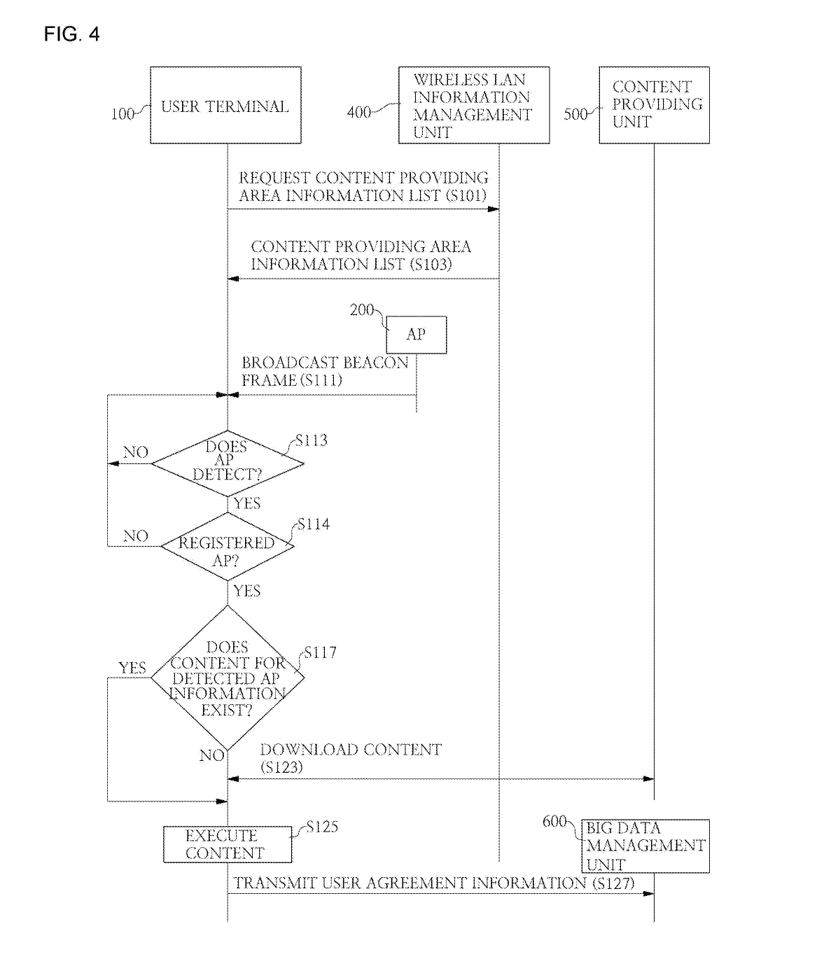

FIG. 4 is a flowchart illustrating a method for automatically providing content in access areas based on access points according to the first embodiment of the present invention. Hereinafter, a method for automatically providing content in access areas based on AP 200 will be described with reference to FIG. 4.

First, a user terminal 100 requests a content providing area information list from a wireless LAN information management unit 400 at step S101. The user terminal 100 may request the content providing area information list when a control program according to the present invention is first executed, or in hour, day, week, and year intervals, or the content providing area information list may be requested when a user makes a request.

When the content providing area information list is requested from the user terminal 100, the wireless LAN information management unit 400 provides the user terminal 100 with the content providing area information list at step S103.

The user terminal 100 checks whether an AP 200 is located around the terminal by checking whether a broadcast beacon frame exists through the wireless communication unit 50 at step S113.

During the checking, when a wireless signal from any AP 200 is received at step S111 and the AP 200 is detected, the user terminal 100 extracts AP information from the wireless signal and stores the AP information in the storage unit.

When the AP information is detected and stored, the user terminal 100 determines whether the AP 200 corresponding to the detected AP information is registered by checking whether content providing area information having AP information, which is the same as the detected AP information, is included in the content providing area information list at step S114.

If the AP corresponding to the detected AP information is registered, the user terminal 100 checks whether content for the registered AP is in the storage unit 20 at step S117.

If the content is in the storage unit 20, the user terminal 100 executes the content at step S125, and if not, the user terminal 100 connects to a content providing unit 500 corresponding to content information of the stored content providing area information, downloads relevant content at step S123, and executes the content at step S125.

While the content is executed, or when the execution of the content has been completed, the user terminal 100 provides user agreement information to the big data management unit 600 depending on a user's agreement on providing user information at step S217. In this case, the user agreement information includes user information, content providing area information for the content providing area 1 in which the user is located, and the like.

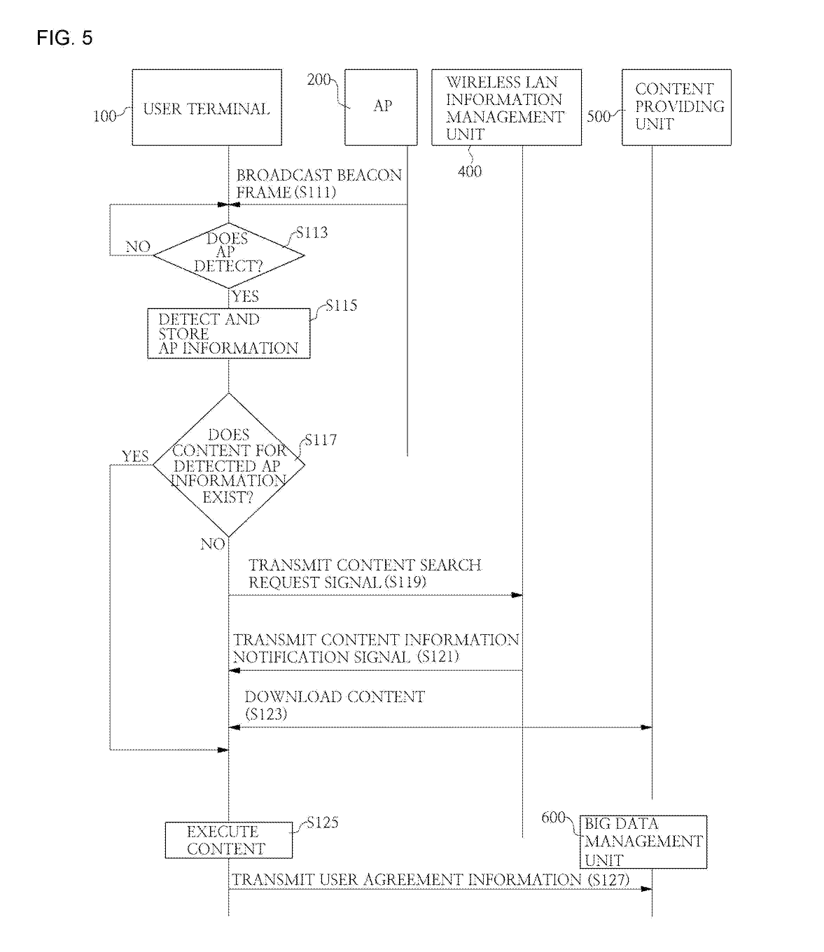

FIG. 5 is a flowchart illustrating a method for automatically providing content in access areas based on access points according to the second embodiment of the present invention.

First, a user terminal 100 checks whether an AP 200 is located around the terminal by checking whether a broadcast beacon frame exists through the wireless communication unit 50 at step S113.

During the checking, when a wireless signal from any AP 200 is received at step S111 and the AP 200 is detected, the user terminal 100 extracts AP information from the wireless signal and stores the AP information in the storage unit 20 at step S115.

When the AP information is detected and stored, the user terminal 100 determines whether previous content for the detected AP information exists at step S117.

If the content exists, the user terminal 100 executes the content at step S125, and if not, the user terminal 100 transmits a content search request signal including the AP information to the wireless LAN information management unit 400 at step S119. For example, when a content providing area formed by the AP 200 having the detected AP information is an LG25 convenience store and the content is an app, the user terminal 100 checks whether an app for the AP information, namely, an app for the LG25 convenience store has been installed in the user terminal. If the app has been installed, the user terminal 100 immediately executes the app. Conversely, if the app for the LG25 convenience store has not been installed, the user terminal 100 transmits a content search request signal including the AP information (in this case, because there is no previous information, the user terminal does not know whether the content providing area 1 is an LG25 convenience store) to the wireless LAN information management unit 400.

The wireless LAN information management unit 400, which received the content search request signal, detects AP information from the content search request signal, searches for content information corresponding to the AP information, contains the content information in a content information notification signal, and provides it to the user terminal 100 at step S121. According to the content type, the content information may include the IP address of a content providing unit 500, app information, a URL address, membership card information, content providing area information, and the like.

The user terminal 100, which received the content information notification signal, connects to a corresponding content providing unit 500, using the content information; transmits a content request signal; downloads relevant content; and stores the content in the storage unit 20 at step S123.

When the content is stored, the user terminal 100 may execute the content at step S125.

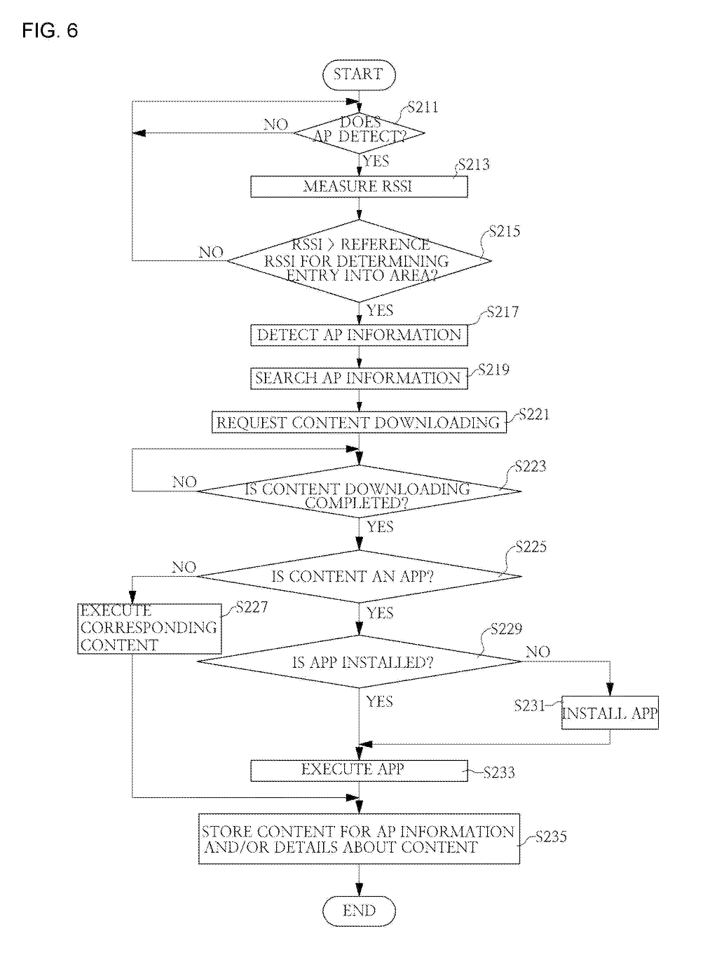

FIG. 6 is a flowchart illustrating a method for automatically providing content in access areas in a first operation example of a user terminal according to the second embodiment of the present invention. The first operation example of a user terminal 100 according to the second embodiment of the present invention will be described with reference to FIG. 6.

First, the AP detection unit 11 of the control unit 10 of a user terminal 100 monitors whether an AP 200 is detected through a wireless communication unit 50 at step S211.

During the monitoring, when any AP 200 is detected, the entry detection unit 12 of the control unit 10 measures an RSSI through an RSSI measurement unit 52 at step S213, and determines whether the terminal enters a content providing area 1 by checking whether the measured RSSI is greater than a preset reference RSSI for determining entry into a content providing area (hereinafter, referred to “reference value for content providing area entry”) at step S215.

If the measured RSSI is greater than the reference value for content providing area entry, the entry detection unit 12 determines that the terminal enters a content providing area 1, and detects AP information from the wireless signal, which is received from the corresponding AP 200, at step S217.

When the AP information is detected, the content search unit 13 generates a content search request signal including the detected AP information, transmits the signal to the wireless LAN information management unit 400, and receives content information in response to the signal at step S219.

When the content information is received, the content search unit 13 connects to a corresponding content providing unit 500, using the content information, and downloads relevant content at steps S221 and S223.

When the content is downloaded, a content execution unit 14 determines whether the content is an app or not at step S225.

If the content is not an app, the content execution unit 14 executes the content, whereas if the content is an app, the content execution unit 14 determines whether an app for the content providing area 1 has been installed at step S229. As a result of the determination, if the app has not been installed, the downloaded app is installed at step S231 and then is executed at step S233. If the app has been installed, the app is immediately executed at step S233.

When the app is executed, the control unit 10 stores the AP information, the content, information about the content execution, and the like, in the storage unit 20 at step S235.

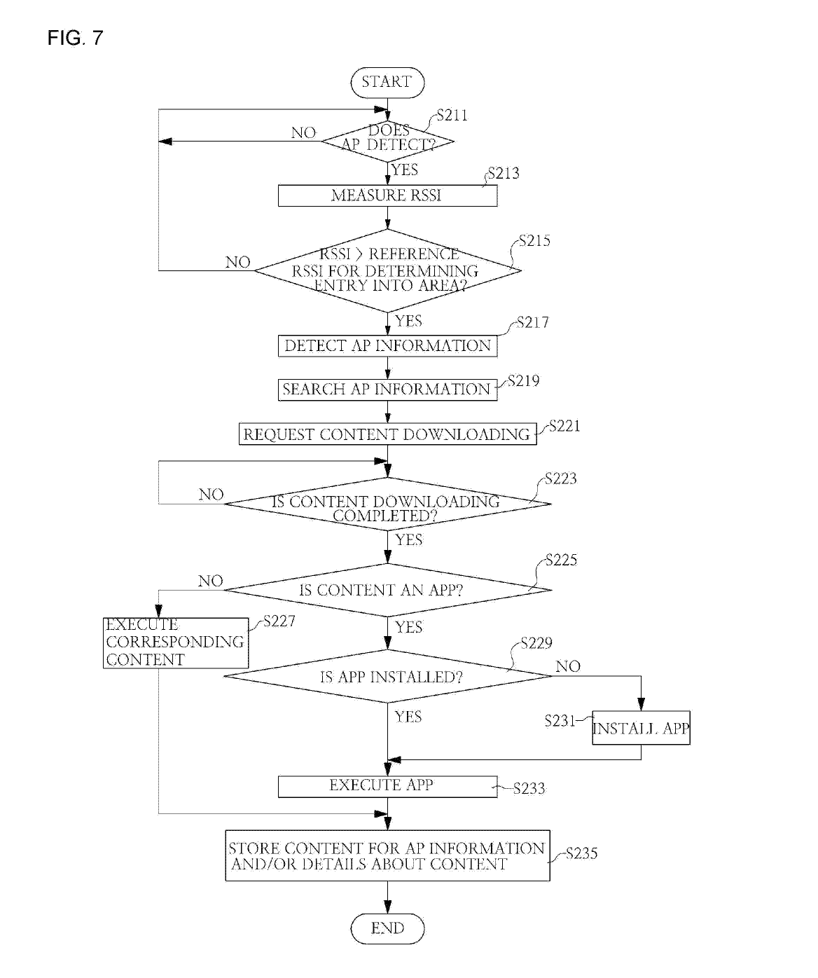

FIG. 7 is a flowchart illustrating a method for automatically providing content in access areas in a second operation example of a user terminal according to the second embodiment of the present invention.

The method of FIG. 6 describes a case in which content is unconditionally downloaded. Hereinafter, referring to FIG. 7, whether previously downloaded content for AP information of the detected AP 200 exists is checked, and the operation depending on whether the previously downloaded content exists will be described.

The control unit 10 of the user terminal 100 performs steps S311 to S317, which are identical to steps S211 to S217 in FIG. 6. Therefore, steps S311 to S317 will not be described.

When AP information is detected at step S317, the content execution unit 14 of the control unit 10 checks whether the previously downloaded content for the detected AP information is in the storage unit 20 at step S319.

As a result of checking, if the previously downloaded content is in the storage unit 20, the content execution unit 14 determines whether the content is an app or not at step S320.

If the content is an app, the content execution unit 14 executes the app at step S333, and stores details about the app execution in the storage unit 20 at step S335. If the content is not an app, the content execution unit executes the content at step S329, and stores the AP information and details about the content execution in the storage unit 20 at step S335.

Conversely, if the previous content information for the detected AP information does not exist in the storage unit 20, the content search unit 13 of the control unit 10 transmits a content search request signal including the AP information to the wireless LAN information management unit 400 to search for content at step S321, downloads content for the detected AP information, and stores the content in the storage unit 20 at steps S323 and S325.

When downloading has been completed, the content execution unit 14 determines whether the downloaded content is an app or other content at step S327.

As a result of the determination, if the content is an app, the content execution unit 14 installs the app at step S331 and then executes the app at step S333.

Conversely, if the content is not an app, the content execution unit 14 executes the content at step S329.

When the content is executed, the content execution unit 14 stores the AP information, the content, and details about the content execution in the storage unit 20 at step S335.

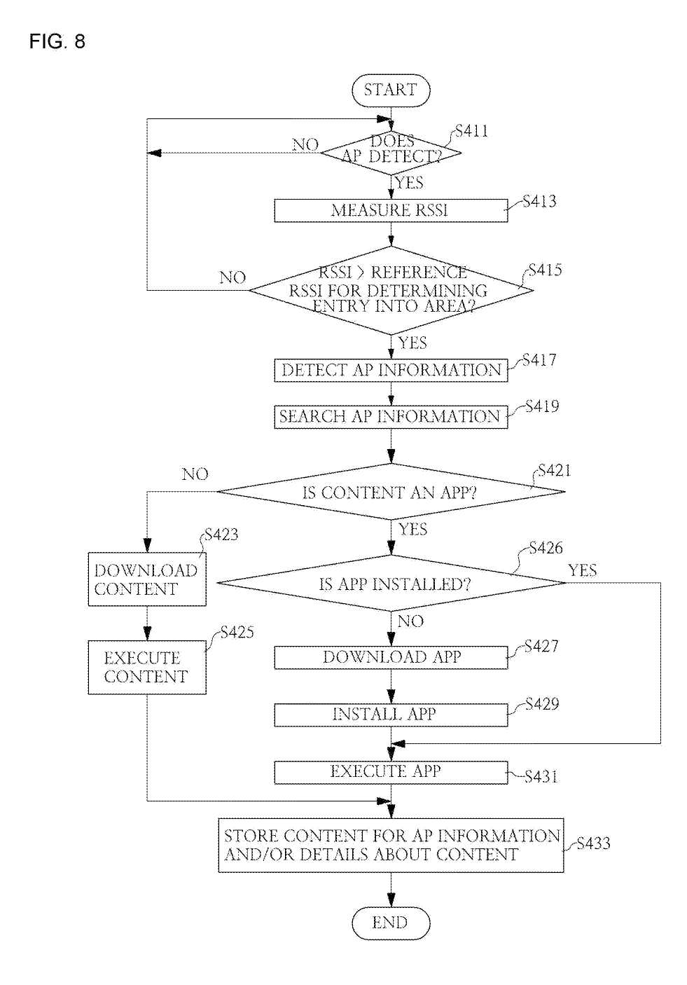

FIG. 8 is a flowchart illustrating a method for automatically providing content in access areas in a third operation example of a user terminal according to the second embodiment of the present invention, and describes a case in which a content type is determined by content information acquired from the wireless LAN information management unit 400.

Referring to FIG. 8, the control unit 10 of the user terminal 100 performs steps S411 to S419, which are the same as steps S211 to S219 in FIG. 6. Therefore, steps S411 to S419 will not be described.

When AP information is found at step S419 and content information for the AP information is received from the wireless LAN information management unit 400, the control unit 10 analyzes the content information and determines whether content is an app or not at step S421.

As a result of the determination, if the content is not an app, the control unit 10 connects to a content providing unit 500 corresponding to the content information, downloads relevant content at step S423, and executes the content at step S425.

Conversely, if the content is an app, the control unit 10 determines whether the app of the content information has been installed at step S426.

As a result of the determination, if the app has not been installed, the control unit 10 connects to a content providing unit 500 corresponding to the content information, downloads the app at step S427, installs the app at step S429, and executes the app at step S431.

FIGS. 6 to 8 describe methods only for the second embodiment. Differently from the second embodiment, the first embodiment does not perform the search process. Accordingly, excluding the search process, the methods of FIGS. 6 to 8 may be applied identically to the content providing area information list that has been stored by previously being received from the wireless LAN information management unit 400.

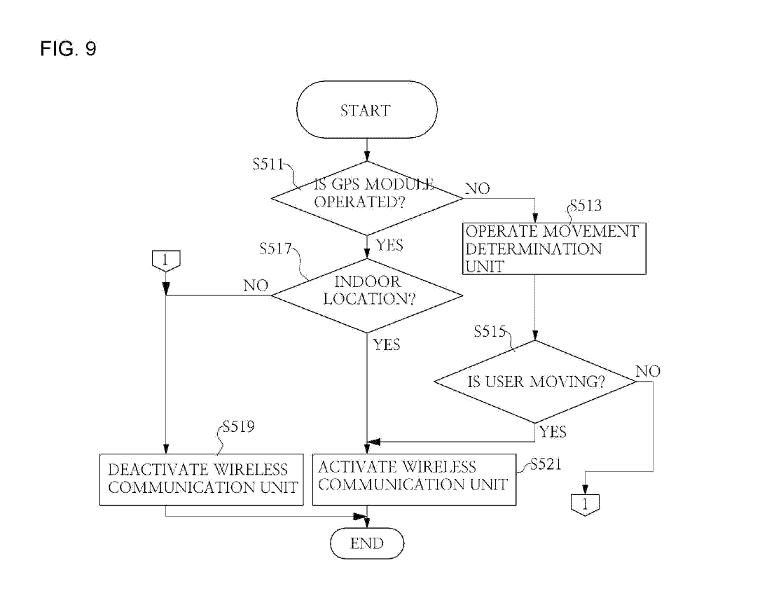

FIG. 9 is a flowchart illustrating a power management method using a GPS module and a gyro sensor in a user terminal according to the present invention.

Referring to FIG. 9, the power management unit 18 of the control unit 10 checks the state of a GPS module 60, namely, whether the GPS module 60 is activated or not at step S511.

As a result of checking, if the GPS module 60 is not activated, the movement determination unit 16 is asked to determine whether a user is moving at step S513. Accordingly, the movement determination unit 16 determines whether a user is moving, by a value measured by the sensor unit 70, and returns the result to the power management unit 18.

The power management unit 18 analyzes the result of the determination of whether the user is moving, and determines whether the user remains stationary at step S515.

When the user is moving, the power management unit 18 activates the wireless communication unit 50 if the wireless communication unit 50 is deactivated, and maintains the state if the wireless communication unit 50 is activated at step S521.

Conversely, when the user remains stationary, the power management unit 18 deactivates the wireless communication unit 50 if the wireless communication unit is activated, and maintains the state if the wireless communication unit 50 is not activated at step S519.

Also, as a result of the determination of whether the GPS module 60 is activated, when it is determined that the GPS module 60 is activated, the power management unit 18 determines whether a current position is an indoor location or an outdoor location depending on whether a GPS signal can be received and depending on the strength of the GPS signal at step S517. In FIG. 9, when a GPS module 60 is used, a power saving mode is set depending on whether the position is an indoor location or an outdoor location. However, the power saving mode may be set by a combination of the determination of the current position and the determination of whether the user is moving, using the location tracing of the GPS module 60.

As a result of the determination, the power management unit 18 activates the wireless communication unit 50 at step S521 when the position is an indoor location, and deactivates the wireless communication unit 50 at step S519 when the position is an outdoor location.

The power management using the GPS module may be selectively operated by the change of the configuration information by the user.

Although the preferred embodiments of the present invention have been disclosed for illustrative purposes, those skilled in the art will appreciate that various modifications, additions and substitutions are possible, without departing from the scope and spirit of the invention as disclosed in the accompanying claims. When these modifications, additions and substitutions are in the scope of the accompanying claims, the technical sprit thereof is also included in the present invention.

<Description of the Reference Numerals in the Drawings>

| | |
|---|---|
| 10: control unit | 11: AP detection unit |
| 12: entry detection unit | 13: content search unit |
| 14: content execution unit | |
| 15: user information providing unit | |
| 16: movement determination unit | 17: timer |
| 18: power management unit | 20: storage unit |
| 30: display unit | 40: input unit |
| 50: communication unit | |
| 51: transmitter-receiver unit | |
| 52: RSSI measurement unit | 60: GPS module |
| 70: sensor unit | |
| 80: battery residual capacity measurement unit | |
| 100: user terminal | 200: AP |
| 300: broadband communication network | |
| 400: wireless LAN information management | |
| unit | |
| 500: content providing unit | |
| 600: big data management unit | |

1. A system for automatically providing content in access areas based on access points, comprising:
a plurality of access points, installed to allow a Wi-Fi zone to cover a certain content providing area, for providing access point information;
one or more content providing units, having multiple pieces of content for one or more content providing areas, for providing content when receiving a request for the content;
a wireless LAN information management unit for storing and managing content information based on an access point, the content information being set according to each of the access points installed in the content providing area, and for providing content information corresponding to access point information when receiving a content search request signal including the access point information; and
a user terminal for detecting the access point, acquiring content information corresponding to the access point information of the access point, connecting to a content providing unit corresponding to the content information, and downloading and executing corresponding content.

2. The system of claim 1, wherein the user terminal comprises:
a storage unit for storing content based on an access point;
a wireless communication unit for receiving a wireless signal transmitted from any access point, detecting access point information included in the received wireless signal, and outputting the access point information; and
a control unit for acquiring content information corresponding to the access point information of the access point when the wireless communication unit detects the access point, connecting to a content providing unit corresponding to the content information, and downloading and executing corresponding content.

3. The system of claim 2, wherein the wireless communication unit comprises:
a transmitter-receiver unit in which a wireless signal is transmitted to and received from a certain access point and the received wireless signal is decoded and output; and
an RSSI measurement unit for measuring and outputting an RSSI of the wireless signal received from the access point,
wherein the control unit comprises,
an access point detection unit for detecting access point information from the decoded data, and outputting the access point information;
an entry detection unit for determining entry into a content providing area by determining whether the RSSI of the received wireless signal is greater than a predetermined reference value for determining entry when the access point is detected by the access point detection unit, the RSSI being measured by the RSSI measurement unit;
a content search unit for transmitting the content search request signal including the access point information to the wireless LAN information management unit via the wireless communication unit when determining the entry into the content providing area, and for receiving content information in response to the content search request signal; and
a content execution unit for connecting to a content providing unit corresponding to the received content information, downloading corresponding content, storing the content in the storage unit, and then executing the content.

4. The system of claim 2, wherein the wireless communication unit comprises:
a transmitter-receiver unit in which a wireless signal is transmitted to and received from any access point and the received wireless signal is decoded and output; and
an RSSI measurement unit for measuring and outputting an RSSI of the wireless signal received from the access point,
wherein the control unit comprises,
an access point detection unit for detecting access point information from the decoded data, and outputting the access point information;
an entry detection unit for determining entry into a content providing area by determining whether the RSSI of the received wireless signal is greater than a predetermined reference value for determining entry when the access point is detected by the access point detection unit, the RSSI being measured by the RSSI measurement unit;
a content search unit for requesting and receiving a content providing area information list including pieces of content providing area information from the wireless LAN information management unit via the wireless communication unit when an event of updating content providing area information occurs, the content providing area information including both area information of a content providing area and access point information; storing the content providing area information list; and determining whether content providing area information, which includes access point information identical to the access point information detected when determining the entry into the content providing area, is included in the content providing area information list; and
a content execution unit for connecting to a content providing unit corresponding to content information of content providing area information when the content providing area information including access point information identical to the detected access point information exists, downloading corresponding content, storing the content in the storage unit, and then executing the content.

5. The system of claim 3, wherein:
the user terminal further comprises a sensor unit that includes one or more of a gyro sensor, an acceleration sensor, and a geomagnetic sensor, and
the control unit further comprises,
a movement determination unit for determining whether a user is moving, depending on whether a user terminal is in motion using a sensed value measured by the sensor unit; and
a power management unit for deactivating the wireless communication unit when the movement determination unit determines that the user remains stationary, and activating the wireless communication unit when it is determined that the user is moving.

6. The system of claim 5, wherein the user terminal further comprises a GPS module for measuring a current position of the user terminal using position data and absolute time data, received from GPS satellites,
wherein the movement determination unit of the control unit determines whether the current position is an indoor location or an outdoor location using the GPS module when the GPS module is activated, and
wherein the power management unit deactivates the wireless communication unit when it is determined by the GPS module that the current position is an outdoor location, and activates the wireless communication unit when it is determined that the current position is an indoor location.

7. The system of claim 3, wherein the user terminal further comprises:
a display unit; and
an input unit that includes a home button and a display on/off change button,
wherein the power management unit of the control unit deactivates the wireless communication unit when a screen of the display unit is turned off, and activates the wireless communication unit when the screen is converted from the off state into an on state by pressing the home button or the display on/off change button.

8. The system of claim 3, wherein the storage unit stores a time for automatically converting to a power saving mode, and
wherein the control unit further comprises a timer for calculating a current time, and deactivates the wireless communication unit when the current time is the time for automatically converting to the power saving mode, and activates the wireless communication unit when the current time is not the time for automatically converting to the power saving mode.

9. The system of claim 1, further comprising,
a big data management unit for receiving and managing user agreement information for the user terminal, and
wherein the user terminal provides the user agreement information to the big data management unit while the content is executed or when execution of the content has been completed.

10. The system of claim 9, wherein the user agreement information comprises user information, and content providing area information for a content providing area in which the user is located, provision of the user information being agreed upon by the user.

11. The system of claim 1, wherein the access point information comprises an SSID and a MAC address.

12. The system of claim 1, wherein the content information is one or more of app identification information, membership card information, and URL information, which correspond to a content providing area.

13. The system of claim 12, wherein when the content information is app identification information, the user terminal determines whether an app corresponding to the app identification information is installed, and when the app is not installed, the user terminal downloads the app from a corresponding content providing unit and installs the app.

14. A method for automatically providing content in access areas based on access points, comprising:
a content information obtaining process in which content information corresponding to AP information of a detected AP is obtained when a user terminal detects the AP; and
a content execution process in which the user terminal connects to a content providing unit corresponding to the obtained content information and downloads and executes content corresponding to the content information.

15. The method of claim 14, wherein the content information obtaining process comprises:
a content providing area information list request step for requesting a content providing area information list including multiple pieces of content providing area information from a wireless LAN information management unit when an event of updating content providing area information occurs, the multiple pieces of content providing area information including both content area information including content information and AP information;
a download step for downloading the content providing area information list from the wireless LAN information management unit in response to the request, and storing the content providing area information list in a storage unit.

16. The method of claim 14, wherein the content information obtaining process comprises:
a content search request step in which, when an AP is detected, a content search request signal including AP information of the detected AP is generated and transmitted to the wireless LAN information management unit; and
a content information obtaining step in which content information is obtained by receiving the content information corresponding to the AP information from the wireless LAN information management unit in response to the request.

17. The method of claim 16, wherein the content search request step comprises:
an AP detection step in which a control unit of the user terminal detects an AP depending on whether a wireless signal is received from any AP through a wireless communication unit;
a content providing area entry determination step in which an RSSI of the wireless signal received from an AP is measured when the AP is detected, and whether the user terminal enters a content providing area is determined by checking whether the measured RSSI is greater than a previously stored reference value for determining entry into a content providing area; and
a content search step in which a search of content is requested when it is determined that the user terminal enters a content providing area.

18. The method of claim 17, wherein the content search request step further comprises:
a content storage determination step in which it is determined whether content for AP information of the detected AP is previously stored in the storage unit when it is determined that the user terminal enters the content providing area in the content providing area entry determination step,
wherein if the content for the AP information is stored in the storage unit, the stored content is executed, and if not, the content search request step is performed.

19. The method of claim 14, wherein the content execution process comprises:
an app determination step in which the user terminal determines whether content of the content information is an app when receiving the content information;
an app installation determination step in which when the content of the content information is an app, whether the app has been installed is checked;
a content download step for connecting to a content providing unit corresponding to the content information when the app has not been installed, and downloading the app that is content corresponding to the content information;
an app installation step in which the downloaded app is installed; and
an app execution step in which the installed app is executed.

20. The method of claim 14, further comprising:
a power saving mode setting process for determining whether a current state is either a power saving mode or a power saving disable mode; deactivating a wireless communication unit when the current state is the power saving mode; and activates the wireless communication unit when the current state is the power saving disable mode,
wherein the content information obtaining process and the content execution process are performed in the power saving disable mode.

21. The method of claim 20, wherein the power saving mode setting process comprises:
an power saving mode determination step in which it is determined whether a current state is either a power saving mode or a power saving disable mode; and
a wireless communication unit activation/deactivation step in which the wireless communication unit is activated or deactivated depending on the set power saving mode.

22. The method of claim 21, wherein the power saving mode determination step comprises:
a sensed value collecting step in which a sensor unit collects sensed values according to movement of the user terminal;
a user movement determination step in which whether a user is moving is determined depending on the movement of the user terminal by the sensed values; and
a power saving mode setting step for setting the power saving disable mode when the user is moving, and setting the power saving mode when the user remains stationary.

23. The method of claim 21, wherein the power saving mode determination step comprises:
a display off detection step for determining whether a screen of a display unit is turned off;
a display on detection step for determining whether a home button signal or a display change button signal is input from an input unit while the screen is turned off; and
a power saving mode setting step for setting the power saving mode when the screen is turned off, and setting the power saving disable mode when the screen is turned on.
